(19) United States
(12) Patent Application Publication
(10) Pub. No.: US 2012/0101903 A1
(43) Pub. Date: Apr. 26, 2012

(54) APPARATUS AND METHOD FOR MOBILE INTELLIGENT ADVERTIZING SERVICE BASED ON MOBILE USER CONTEXTUAL MATCHING

(75) Inventors: Hyo Jung OH, Daejeon (KR); Chung Hee Lee, Daejeon (KR); Hyun Ki Kim, Daejeon (KR); Pum Mo Ryu, Daejeon (KR); Soo Jong Lim, Daejeon (KR); Jeong Heo, Daejeon (KR); Chang Ki Lee, Daejeon (KR); Mi Ran Choi, Daejeon (KR); Yeo Chan Yoon, Seoul (KR); Yoon Jae Choi, Chuncheon-si (KR); Myung Gil Jang, Daejeon (KR); Sang Kyu Park, Daejeon (KR)

(73) Assignee: ELECTRONICS AND TELECOMMUNICATIONS RESEARCH INSTITUTE, Daejeon (KR)

(21) Appl. No.: 13/192,059

(22) Filed: Jul. 27, 2011

(30) Foreign Application Priority Data
Oct. 25, 2010 (KR) 10-2010-0104023

(51) Int. Cl. G06Q 30/00

(52) U.S. Cl. 705/14.66

(57) ABSTRACT

Disclosed are a method and an apparatus for mobile intelligent advertizing service based on mobile user contextual matching. An apparatus for mobile intelligent advertizing service based on mobile user contexts includes: a contextual information collecting unit collecting user contextual information under a mobile environment; a contextual information analyzing unit analyzing the collected contextual information and classifying and storing the analyzed contextual information for each category; a contextual information modeling unit comparing and mapping the analyzed contextual information with a previously built-up contextual information database to formalize the compared and mapped contextual information and generalizing the formalized contextual information by using a wired/wireless communication network; a user action analyzing unit analyzing a user's action on the basis of the modeled contextual information and predicting the user's next action; and an advertisement contents recommending unit recommending advertisement contents suitable for the predicted user's next action.

### CROSS-REFERENCE TO RELATED APPLICATIONS

This application claims priority under 35 U.S.C. §119 to Korean Patent Application No. 10-2010-0104023, filed on OCTOBER 25, 2010, in the Korean Intellectual Property Office, the disclosure of which is incorporated herein by reference in its entirety.

### TECHNICAL FIELD

The present invention relates to a method and an apparatus for mobile intelligent advertizing service based on mobile user contextual matching, and more particularly, to a method and an apparatus for mobile intelligent advertizing service based on mobile user contextual matching capable of improving an advertisement exposure effect by actively collecting and analyzing, and modeling various contexts under a user mobile environment and recommending a user contextual matching advertisement through analysis and prediction of a user's action based on the modeled contexts.

### BACKGROUND

In mobile communication markets, new services have been continuously required to be produced through recombination or integrations of the existing technologies, and today, with the development of communication and broadcasting technologies, broadcasting services have been provided through mobile terminals such as a cellular phone, a personal digital assistant (PDA), and the like in the known broadcasting system or mobile communication system.

These potential and actual market demands and user requirements that rapidly increase with respect to a multimedia service, a strategy of a provider who intends to provide a new service such as a broadcasting service in addition to the existing voice service, and interests of information technology (IT) companies who are strengthening the mobile communication business by accepting the user demands collide with each other, such that the convergence of the mobile communication service and an Internet protocol (IP) network has become a large trend of technological development of next-generation mobile communications.

Meanwhile, the Open Mobile Alliance (OMA), which is the organization that studies a standard for interworking individual mobile solutions, primarily determines various application standards for a mobile communication game, an Internet service, and the like. The Open Mobile Alliance Requirement Working Group among working groups of the OMA is studying a mobile advertising service (MobAd) technology.

The mobile advertising service is a technology that transmits a personal advertisement based on technologies such as music, graphic, voice, text, and the like to a user of a mobile terminal through the mobile terminal (including a mobile phone, a PDA, or the like).

Although there are a lot of solutions supporting the mobile advertising service, compatibility and spreading ability) are deteriorated due to the use of software only for each company and provider. Accordingly, in order to solve the problems, the OMA are establishing the standard MobAd for the related technologies.

The mobile advertising service has the following three features. First, an information database for a user can be constructed and a personalized advertisement suitable for individual characteristics can be implemented. Since the user carries the mobile terminal at all times, advertisement contents selected by the user may be transmitted to the user according to a cycle determined by the provider or a request from the user and an advertisement through the mobile terminal can be exposed to the user at all times.

Second, bidirectional interaction is available. Since a mobile advertisement can provide in advance information regarding an advertisement which the user desires and a phone number or a uniform resource locator (URL) at once, the user can actively acquire more detailed information regarding a product.

Third, user metrics can be measured. Since the mobile terminal is a bidirectional medium, the mobile terminal can induce reactions of users exposed to the advertisement. The metrics can be appropriately used for analyzing user preference or marketing.

The related art for providing the mobile advertising service is merely limited in using only limitative information such as a user's location, a time mobile, query log, or the like.

For example, the mobile advertising service in the related art recognizes surrounding contexts by using only weather, location, time, and appliance information provided from a predetermined device connected to the mobile terminal or using only personal information which the user records in the mobile terminal and provides an advertisement based on the analyzed contextual information.

As described above, since the mobile advertising service in the related art depends on only the information provided from the predetermined device connected to the mobile terminal, the mobile advertising service cannot provide an optimal advertisement by actively coping with contexts which vary in real time.

### SUMMARY

An exemplary embodiment of the present invention provides an apparatus for mobile intelligent advertizing service based on mobile user contextual matching, the apparatus including: a contextual information collecting unit collecting user contextual information including at least one of user external contextual information, user operational contextual information, user social contextual information, and user concern contextual information under a mobile environment; a contextual information analyzing unit analyzing the collected contextual information and classifying and storing the analyzed contextual information for each category; a contextual information modeling unit comparing and mapping the analyzed contextual information with a previously built-up contextual information database to formalize the compared and mapped contextual information and generalizing the formalized contextual information by using a wired/wireless communication network; a user action analyzing unit analyzing a user's action on the basis of the modeled contextual information and predicting the user's next action; and an advertisement contents recommending unit recommending advertisement contents suitable for the predicted user's next action.

Another exemplary embodiment of the present invention provides a method for mobile intelligent advertizing service based on mobile user contextual matching, the method including: collecting a plurality of user contextual information under a mobile environment; analyzing the collected contextual information; modeling the analyzed contextual information; analyzing a user's action on the basis of the modeled contextual information and predicting the user's next action; recommending advertisement contents suitable for the predicted user's next action; and transmitting the recommended advertisement contents to a mobile terminal.

Other features and aspects will be apparent from the following detailed description, the drawings, and the claims.

### BRIEF DESCRIPTION OF THE DRAWINGS

FIG. 1 is a block diagram showing an apparatus for mobile intelligent advertising service based on mobile user contexts according to an exemplary embodiment of the present invention.

FIG. 2 is a diagram showing plural contextual information to be collected according to an exemplary embodiment of the present invention.

FIG. 3 is a diagram showing an example of a method in which a mobile intelligent advertizing service based on mobile user contexts according to an exemplary embodiment of the present invention is serviced.

FIG. 4 is a diagram showing another example of a method in which a mobile intelligent advertizing service based on mobile user contexts according to an exemplary embodiment of the present invention is serviced.

FIG. 5 is a flowchart showing a method for mobile intelligent advertising service based on mobile user contexts according to another exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

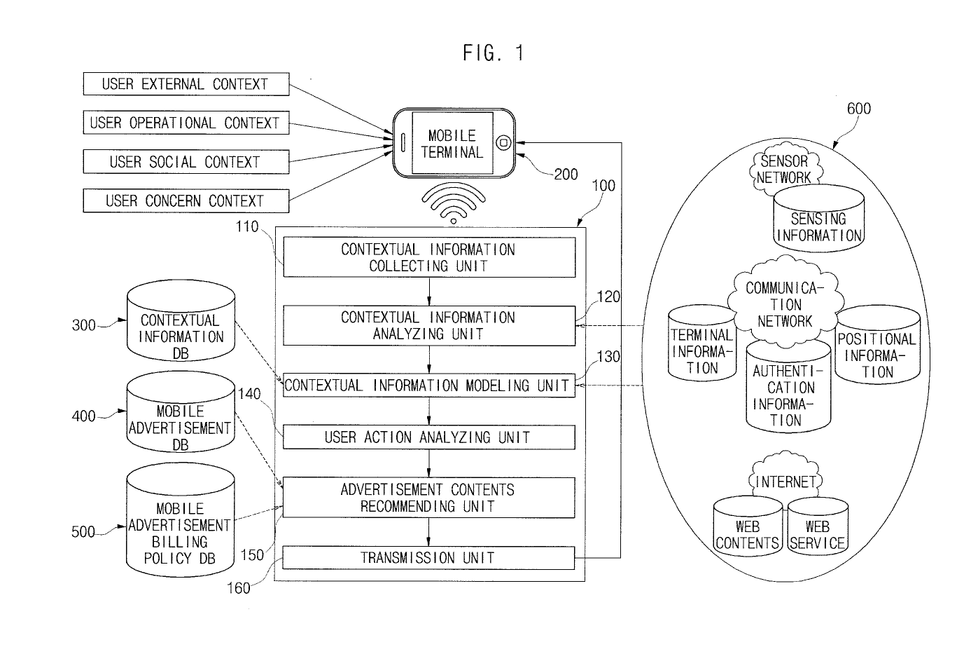

Hereinafter, referring to FIG. 1, an apparatus for mobile intelligent advertising service based on mobile user contexts according to an exemplary embodiment of the present invention will be described. FIG. 1 is a block diagram showing an apparatus for mobile intelligent advertizing service based on mobile user contexts according to an exemplary embodiment of the present invention.

Referring to FIG. 1, the apparatus 100 for mobile intelligent advertizing service based on mobile user contexts according to the exemplary embodiment of the present invention is configured to include a contextual information collecting unit 110, a contextual information analyzing unit 120, a contextual information modeling unit 130, a user action analyzing unit 140, an advertisement contents recommending unit 150, and a transmission unit 160.

The contextual information collecting unit 110 collects plural user contextual information from a mobile terminal 200. The user contextual information may include at least one of user external contextual information, user operational contextual information, user social contextual information, and user concern contextual information.

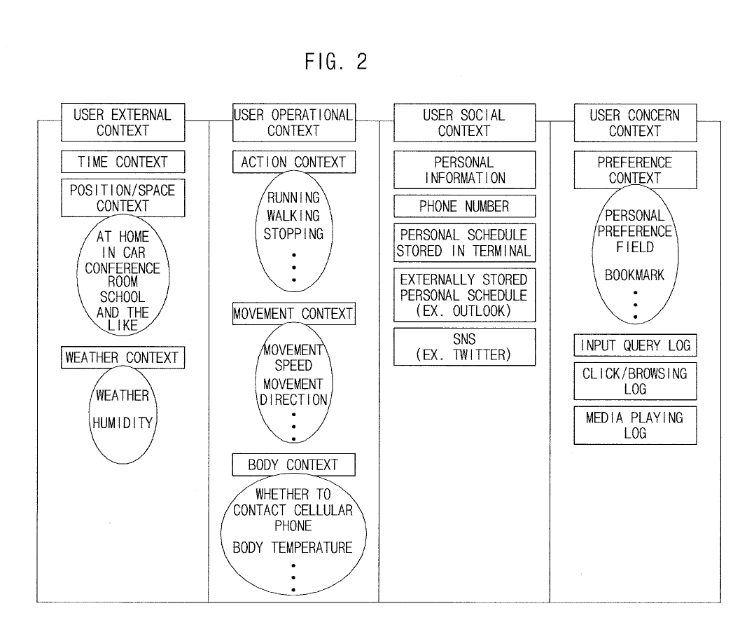

Hereinafter, the user contextual information will be described in detail with reference to FIG. 2. FIG. 2 is a diagram showing plural contextual information to be collected according to an exemplary embodiment of the present invention.

Referring to FIG. 2, the user external contextual information includes current time contextual information, space contextual information (e.g., information as to whether a user is at home, in a car, in a conference room, or in a place such as a school, or the like) where a user having a mobile terminal is positioned, or weather contextual information.

The user external contextual information may be collected by the mobile terminal 200. More specifically, external environment contextual information such as temperature, humidity, weather, and the like may be collected by sensors embedded in the mobile terminal 200 and space contextual information where the user is positioned at present may be collected through coordinate information collected by an embedded GPS receiving module.

Further, the user external contextual information may be collected through a short-range radio communication (radio frequency identification, RFID). To enable this, an RFID reader module may be embedded in the mobile terminal 200 and external contextual information may be collected through information which the RFID reader module reads from an RFID tag attached in the surroundings.

[symbol] RFID [symbol] [symbol] [symbol] tag

[symbol]

[symbol]

[symbol]

The user operational contextual information is associated with user's body operations and includes user action contextual information (e.g., running, walking, stopping states), movement contextual information (e.g., movement speed and movement direction), and body contextual information (e.g., information as to whether to contact the mobile terminal and body temperature).

The user social contextual information refers to information such as a user personal schedule, a user phone number, a user social network, and the like, and may be collected through information stored in the mobile terminal 200 or information stored in an external communication network 600 (e.g., external servers such as Outlook Express, Twitter, and the like).

The user concern contextual information refers to user information needs, and more specifically, may be acquired from user usage history information generated by monitoring and accumulating user actions such as query words which the user inputs in the mobile terminal 200 or mobile media (e.g., mobile web, image, moving picture, and the like) which the user browses through the mobile terminal 200.

The detailed contents thereof are analyzed by using web contents and web services on an external communication network 600 (e.g., Internet).

The contextual information analyzing unit 120 receives the information collected by the mobile terminal 200 as describe above and analyzes the collected user contextual information and classifies and stores the collected user contextual information for each category.

The contextual information modeling unit 130 compares and maps the user contextual information classified and stored for each category to formalize the compared and mapped user contextual information by referring to a previously built-up contextual information database 300 and generalizes the formalized user contextual information by using the external communication network 600.

In the contextual information database 300, the user contextual information is coarsely classified into the user external contextual information, the user operational contextual information, the user social contextual information, and the user concern contextual information and the coarsely classified information may be classified and stored for each category.

For example, the contextual information modeling unit 130 compares and matches the user contextual information stored for each category and the previously built-up information in the contextual information database 300 for each category to extract information with the highest similarity from the contextual information database 300 for each category.

As described above, the user contextual information extracted from the contextual information database 300 for each category is collected and formalized and the formalized user contextual information is converted into generalized information by the external communication network 600.

The user action analyzing unit 140 analyzes a user's action and predicts the user's next action on the basis of the modeled user contextual information.

More specifically, the user action analyzing unit 140 determines a user's action pattern on the basis of the modeled user contextual information and predicts the user's next action on the basis of the determined action pattern and the modeled user contextual information to set a contextual condition for the user's next action.

The advertisement contents recommending unit 150 recommends advertisement contents suitable for the predicted user's next action.

More specifically, the advertisement contents recommending unit 150 retrieves advertisement contents depending on the set contextual condition from a previously built-up mobile advertisement database 400 and ranks the retrieved advertisement contents according to the contextual condition.

Thereafter, the advertisement contents recommending unit 150 selects advertisement billing by referring to a previously set mobile advertisement billing policy database 500 with respect to each of the ranked advertisement contents.

Next, the advertisement contents recommending unit 150 re-ranks the ranked advertisement contents by using a weight value between adaptability of the retrieved advertisement contents to the contextual condition and the selected advertisement billing.

The re-ranked advertisement contents are transmitted to the mobile terminal 200 through the transmission unit 160.

In this case, the advertisement contents are transmitted to the mobile terminal 200 according to a user's demand context and an advertizing purpose. To enable this, the advertisement contents may be transmitted when the modeled contextual information matches an advertisement context previously defined by the user or may be together transmitted at the time of presenting the corresponding information when the user inputs a query or requests information.

Alternatively, the advertisement contents may be transmitted together with the corresponding media at the time when the user accesses (browses, views, and plays) the mobile media (mobile webpage, image, moving picture, and the like).

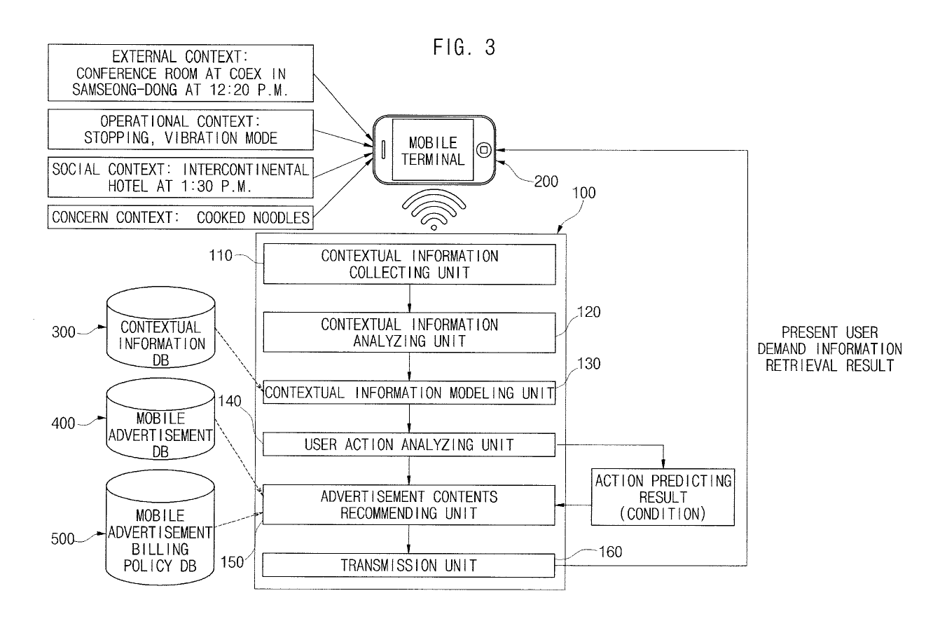

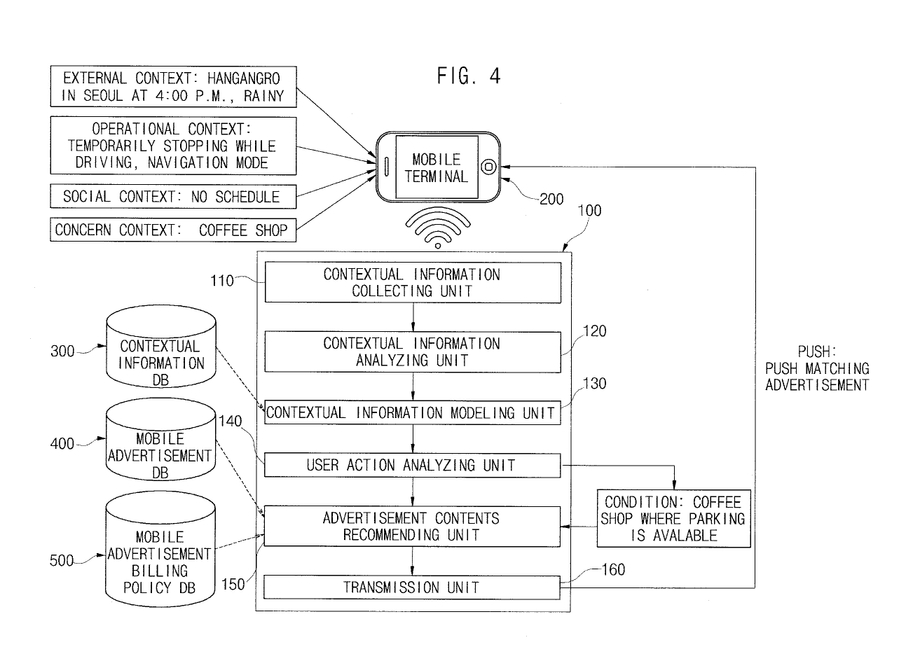

Hereinafter, referring to FIGS. 3 and 4, an example in which intelligent advertising service based on mobile user contexts according to an exemplary embodiment of the present invention is serviced will be described in detail.

FIG. 3 is a mobile intelligent advertizing service using an advertisement recommending method based on a user contextual matching, and shows a process of selecting advertisement contents matching the context when the user inputs in the mobile terminal a query, “a great place to have lunch in the neighborhood -> partner [symbol] [symbol] ”.

In this case, on the assumption that the user ends a conference in a conference room at COEX in Samseong-dong, Seoul at 12:20 p.m., user external contexts are collected and analyzed as follows through processes of contextual information collection and contextual information analysis by an apparatus for mobile intelligent advertizing service based on mobile user contexts according to the exemplary embodiment of the present invention.

“Time context: 12:20 p.m.

Position context: COEX in Samseong-dong, Seoul

Space context: Conference room

Weather context: Clear

Conference members: 10 members”

Similarly, it is analyzed that the user operational context is a “stop” mode and the mobile terminal is in a vibration mode. Through the user social context, it can be found that the next conference is held at a neighboring place (a seminar room of Intercontinental Hotel) at 1:30 p.m., and it is determined that the user is interested primarily in cooked noodles such as cold noodles, chopped noodles, and the like through a user's previous delicious restaurant retrieval log from the user concern contextual information.

The collected and analyzed contextual information is formalized by the contextual information modeling unit and the user action analyzing unit establishes an assumption that the user will quickly eat a meal around here and move to the next place, on the basis of the formalized contextual information. User contextual information modeling and action analyzing and predicting results are as follows.

“Time context: 12:20 p.m.

Position context: COEX in Samseong-dong, Seoul

Action prediction: The user should move to another place by 1:30 p.m.

Condition: cooked noodles which 10 persons can quickly eat”

The advertisement contents recommending unit selects an advertisement most matching the analyzed and modeled contextual information and the action analyzing and predicting results. Herein, advertisement contents based on user contextual matching are transmitted to the mobile terminal through a method of presenting a user demand information retrieving result.

FIG. 4 is a diagram showing an example in which a result of recommending an advertisement based on user contextual matching is transmitted to a mobile terminal through a matching advertisement pushing method by using a method of recommending an advertisement based on user contextual matching, and shows a process of selecting advertisement contents matching a context when a user temporarily stops driving on a road around Namsan in Seoul at 4:00 p.m. in a rainy day.

In this case, the user external context is collected and analyzed by the contextual information collecting unit and the contextual information analyzing unit as follows.

“Time context: 4:00 p.m.

Position context: Hangangro around Namsan in Seoul

Space context: On a road

Weather context: Rainy”

Herein, it is analyzed that the user operational context is in a “vehicle that stops while moving” state and the mobile terminal is in a navigation mode. Through the user social context, it can be found that there is no schedule in the afternoon, and through the user concern context, a history to frequently visit a coffee shop in the rainy day is inquired through a user's previous log.

The collected and analyzed contextual information is formalized through the contextual information modeling unit and the user action analyzing unit predicts that a possibility to visit a coffee shop where parking is available is high with respect to the user's next action on the basis of the formalized contextual information.

The advertisement contents recommending unit recommends an advertisement for the coffee shop or a tea shop where parking is available around Hangangro of Namsan in Seoul and the transmission unit pushes the recommended advertisement to a mobile terminal screen which operates in a navigation mode.

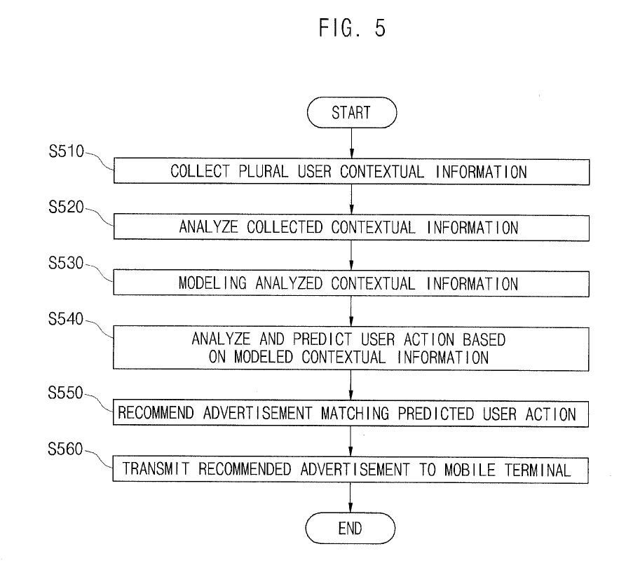

Hereinafter, referring to FIG. 5, a method for mobile intelligent advertising service based on mobile user contexts according to another exemplary embodiment of the present invention will be described. FIG. 5 is a flowchart showing a method for mobile intelligent advertising service based on mobile user contexts according to another exemplary embodiment of the present invention.

First, the contextual information collecting unit collects plural user contextual information from a mobile terminal under a mobile environment (S510). The user contextual information may include at least one of user external contextual information, user operational contextual information, user social contextual information, and user concern contextual information.

Next, the contextual information analyzing unit receives the information collected by the mobile terminal as described above, analyzes the collected user contextual information, and classifies and stores the collected user contextual information for each category (S520).

In addition, the contextual information modeling unit formalizes the user contextual information classified and stored for each category through comparing and mapping by referring to a previously built-up contextual information database and generalizes the formalized user contextual information by using an external communication network (S530).

For example, the contextual information modeling unit compares and matches the user contextual information stored for each category with the previously built-up information in the contextual information database for each category to extract information with the highest similarity from the contextual information database for each category, and the user contextual information extracted for each category may be collected and formalized and the formalized user contextual information may be converted into generalized information by the external communication network.

In addition, the user action analyzing unit analyzes a user action and predicts the user's next action on the basis of the modeled user contextual information (S540).

For example, the user action analyzing unit determines a user's action pattern on the basis of the modeled user contextual information and predicts the user's next action on the basis of the determined action pattern and the modeled user contextual information to set a contextual condition for the user's next action.

Next, the advertisement contents recommending unit retrieves advertisement contents depending on the set contextual condition from the previously built-up mobile advertisement database, ranks the retrieved advertisement contents according to the contextual condition, and re-ranks the ranked advertisement contents according to the predetermined mobile advertisement billing policy (S550).

The re-ranked advertisement contents are transmitted to the mobile terminal through the transmission unit (S560).

According to exemplary embodiments of the present invention, it is possible to provide a method of recommending an advertisement suitable for the predicted action by actively collecting and analyzing, and modeling various user contexts in a mobile environment, which include a user external environment including weather and space, a user operational context, a social context such as a personal schedule, a personal concern, and the like, and analyzing a user action by using the collected, analyzed, and modeled user contexts, and predicting a user's next action, by deviating from a known method using only limitative information such as a user's location, a time, a mobile query log, and the like in a mobile intelligent advertizing service.

As a result, since an exposure effect of the corresponding advertisement can be maximized, satisfaction of an advertiser can be improved in the end.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for mobile intelligent advertizing service based on mobile user contexts, the apparatus comprising:
a contextual information collecting unit collecting user contextual information including at least one of user external contextual information, user operational contextual information, user social contextual information, and user concern contextual information under a mobile environment;
a contextual information analyzing unit analyzing the collected contextual information and classifying and storing the analyzed contextual information for each category;
a contextual information modeling unit comparing and mapping the analyzed contextual information with a previously built-up contextual information database to formalize the compared and mapped contextual information and generalizing the formalized contextual information by using a wired/wireless communication network;
a user action analyzing unit analyzing a user's action on the basis of the modeled contextual information and predicting the user's next action; and
an advertisement contents recommending unit recommending advertisement contents suitable for the predicted user's next action.

2. The apparatus of claim 1, wherein the user action analyzing unit determines a user's action pattern on the basis of the modeled user contextual information and predicts the user's next action on the basis of the determined action pattern and the modeled contextual information to set a contextual condition for the user's next action.

3. The apparatus of claim 2, wherein the advertisement contents recommending unit retrieves the advertisement contents depending on the set contextual condition from a previously built-up mobile advertisement database and ranks the retrieved advertisement contents according to the contextual condition.

4. The apparatus of claim 3, wherein the advertisement contents recommending unit re-ranks the ranked advertisement contents according to a predetermined mobile advertisement billing policy.

5. The apparatus of claim 1, further comprising a transmission unit transmitting the recommended advertisement contents to a mobile terminal.

6. The apparatus of claim 5, wherein the transmission unit transmits the advertisement contents to the mobile terminal when the modeled contextual information matches the advertisement contents.

7. The apparatus of claim 5, wherein the transmission unit transmits the advertisement contents to the mobile terminal in addition to information requested by a user.

8. The apparatus of claim 5, wherein the transmission unit transmits the advertisement contents suitable for the contextual information to the mobile terminal in addition to media contents at the time when the user accesses mobile media.

9. A method for mobile intelligent advertizing service based on mobile user contexts, the method comprising:
collecting plural user contextual information under a mobile environment;
analyzing the collected contextual information;
modeling the analyzed contextual information;
analyzing a user's action on the basis of the modeled contextual information and predicting the user's next action;
recommending advertisement contents suitable for the predicted user's next action; and
transmitting the recommended advertisement contents to a mobile terminal.

10. The method of claim 9, wherein the user contextual information includes at least one of user external contextual information, user operational contextual information, user social contextual information, and user concern contextual information.

11. The method of claim 10, wherein the collecting includes receiving the user external contextual information received by a sensor and an RFID module embedded in the mobile terminal from the mobile terminal.

12. The method of claim 10, wherein the collecting includes receiving the user operational contextual information associated with a user's body operation including user's movement speed and direction, whether a user possesses the mobile terminal, user's body temperature, and the like from the mobile terminal.

13. The method of claim 10, wherein the collecting includes receiving the user social contextual information including a user personal schedule, a user phone number, a user social network, and the like from the mobile terminal or an external communication network.

14. The method of claim 10, wherein the collecting includes receiving the user concern contextual information including user usage history information generated by monitoring and accumulating user actions for the mobile terminal from the mobile terminal.

15. The method of claim 9, wherein the modeling of the contextual information includes:
comparing and mapping the analyzed contextual information with a previously built-up contextual information database to formalize the compared and mapped contextual information; and
generalizing the formalized contextual information by using a wired/wireless communication network.

16. The method of claim 9, wherein the predicting of the user's next action includes:
determining a user's action pattern on the basis of the modeled contextual information,
predicting the user's next action on the basis of the determined action pattern and the modeled contextual information; and
setting a contextual condition for the predicted user's next action.

17. The method of claim 16, wherein the recommending of the advertisement contents includes:
retrieving advertisement contents depending on the set contextual condition from a previously built-up mobile advertisement database;
ranking the retrieved advertisement contents according to the contextual condition; and
re-ranking the ranked advertisement contents according to a predetermined mobile advertisement billing policy.

18. The method of claim 9, wherein the transmitting to the mobile terminal includes transmitting the advertisement contents to the mobile terminal when the modeled contextual information matches the advertisement contents.

19. The method of claim 9, wherein the transmitting to the mobile terminal includes transmitting the advertisement contents to the mobile terminal in addition to information requested by the user.

20. The method of claim 9, wherein the transmitting to the mobile terminal includes transmitting the advertisement contents suitable for the contextual information to the mobile terminal in addition to media contents at the time when the user accesses mobile media.
